(19) United States
(12) Patent Application Publication
(10) Pub. No.: US 2026/0121484 A1
(43) Pub. Date: Apr. 30, 2026

(54) ELECTRIC PUMP WITH VACUUM-IMPREGNATED HOUSING AND STATIONARY RUNNING AXLE

(71) Applicant: Nidec GPM GmbH, Auengrund OT Merbelsrod (DE)

(72) Inventor: Franz PAWELLEK, Lautertal (DE)

(21) Appl. No.: 19/362,546

(22) Filed: Oct. 20, 2025

(30) Foreign Application Priority Data
Oct. 25, 2024 (DE) 10 2024 131 166.5

(51) Int. Cl. H02K 7/14; B60H 1/00; F04D 13/06; H02K 15/122; H02K 15/14

(52) U.S. Cl. CPC H02K 7/14; H02K 15/122; H02K 15/14; B60H 1/00428; F04D 13/06

(57) ABSTRACT

An electric pump includes a motor housing, a stator located in the motor housing and a rotor assembly circumferentially surrounding the stator. The motor housing is vacuum-impregnated and the rotor assembly is traversed by a stationary running axle pressed into the motor housing or into a stiffening disc connected to the motor housing.

### CROSS REFERENCE TO RELATED APPLICATIONS

This application claims the benefit of priority to German Patent Application No. 10 2024 131 166.5 filed on Oct. 25, 2024. The entire contents of this application are hereby incorporated herein by reference.

### 1. FIELD OF THE INVENTION

The present invention relates to electric pumps with motor housings, stators, and rotor assemblies and to the use of the electric pumps as coolant pumps in vehicles.

### 2. BACKGROUND

Electric coolant pumps can be used in vehicles with combustion engines, hybrid and electric vehicles, and even in models with fuel cell drives. They optimize thermal management with their cooling.

For these purposes it is known to use electric coolant pumps with a split pot. A plastic split pot with a typical wall thickness of 1 mm is usually used. This results in a very large magnetic air gap. Due to the resulting field losses, the motor must be larger and more expensive than a motor with a smaller air gap. The plastic can also acts as an insulator and thus hinders the dissipation of heat loss from the stator into the coolant. Metallic split pots with good heat dissipation are also known, but these result in considerable eddy current losses.

The stator of the electric motor of the electric coolant pumps can, for example, be formed by overmolding. However, the disadvantage is that overmolding requires a high tooling cost, especially when using different sheet metal stack heights.

In the manufacture of electric motors, the impregnation of stators is a common process used to stabilize the windings and to improve heat dissipation from the stator into the cooling medium. The impregnating agent also penetrates into cavities, but also builds up and changes the dimensions of the stator. During curing, drips also form, which can make it difficult to press the stator into a housing, for example.

### SUMMARY

Example embodiments of the present disclosure provide electric pumps that are particularly simple and inexpensive to manufacture.

Accordingly, an example embodiment of the present invention provides an electric pump including a motor housing, a stator located in the motor housing, and a rotor assembly circumferentially surrounding the stator. The motor housing is at least partially vacuum-impregnated and the rotor assembly is traversed by a stationary running axle pressed into the motor housing or into a stiffening disc connected to the motor housing.

Pressing the running axle into the motor housing is a comparatively robust assembly process that allows for greater tolerances and higher pressing forces. Vacuum impregnation of the motor housing protects the housing against external and internal corrosive influences and also allows the use of inexpensive, uncoated materials.

The motor housing is preferably manufactured by deep drawing, in particular from sheet steel, and can therefore be produced particularly cost-effectively without requiring any machining rework.

It is particularly advantageous if the motor housing and the stator are vacuum-impregnated as an assembly. Because the entire assembly is vacuum impregnated, there are no problems inserting the stator into the housing due to dimensions of the layer structure of the impregnating agent, as is the case with impregnating stators. Conventional stator overmolding is no longer necessary, and the wound stator of an example embodiment of the present disclosure is electrically insulated from a cooling medium when used in an electric coolant pump. In addition, the impregnating agent can be used to bond the stator windings and existing sheet metal laminations, which improves acoustics and heat dissipation. Vacuum impregnation of the entire assembly also achieves a secure fixation of the stator in the housing. In addition, the adhesive bond between the stator and the housing stiffens the thin-walled housing, eliminating the need for a thick-walled and heavy housing.

In an example embodiment, the stator is preferably fixed in the housing by welding, caulking, or press-fitting. When caulking, the housing can be pressed into grooves in the stator insulators from the outside.

Preferably, an example embodiment of the present disclosure provides a pump including a rotor assembly that is rotatably mounted on the running axle within the stator, wherein the rotor assembly includes an impeller and a magnetic rotor. The impeller can be provided integrally with a rotor adapter to which a rotor magnet, in particular a ferrite ring magnet, is attached. At an end spaced away from a bearing seat, a rotor adapter preferably includes a receptacle into which an axial thrust washer is pressed. A spiral housing is preferably attached to the motor housing, for example, by centering sleeves. The motor housing could be surrounded by a plug housing. The plug housing is preferably an aluminum housing manufactured by deep drawing, for example. A printed circuit board may be accommodated in the plug housing. The printed circuit board is preferably connected to the outside of the bottom of the housing via a thermal pad, allowing it to be cooled effectively. The ends of the winding wires leading out of the motor housing are preferably electrically connected to the printed circuit board. The plug housing preferably includes a plug geometry and electrical contacts located therein, which are connected to the printed circuit board.

The stator preferably includes sheet metal laminations from which individual stator core segments are provided, around which the coils of winding wires are wound. Ends of the winding wires are preferably led out through openings in the housing base to directly contact with a printed circuit board. The housing base preferably includes insertion chamfers to align the ends of the winding wires. This eliminates the need for a busbar assembly.

In one example embodiment of the present disclosure, the housing is pot-shaped with a base and a cylindrical outer surface, and the base includes a central recess with a through-opening. The running axle is pressed into a seat defined by the recess.

In another example embodiment of the present disclosure, the housing is pot-shaped with a base and a cylindrical outer surface, the base includes a central opening through it, a stiffening disc lying on an outside of the base and projecting into the opening and into the interior of the housing with a circular ring-shaped projection. An inside of the circular ring-shaped projection defines a seat into which the running axle is pressed. The base is reinforced by the stiffening disc, and the stiffening disc absorbs the forces occurring when the running axle is pressed in.

In another example embodiment of the present disclosure, the housing is pot-shaped with a base and a cylindrical outer surface. The base includes a central through-opening. A stiffening disc is located on the inside of the base and includes an inwardly projecting circular ring-shaped projection. The inside of the circular ring-shaped projection defines a seat into which the running axle is pressed. In this case, too, the base is reinforced by the stiffening disc, and the stiffening disc absorbs the forces occurring when the running axle is pressed in.

The stiffening disc can be a sintered disc made of porous material or an aluminum disc.

Preferably, the stiffening disc includes a through-opening in the center of the circular ring-shaped projection. The through-opening is shaped to correspond to the opening in the base.

It is particularly advantageous if the seat is kept free of impregnating agents. Pressing in is then carried out with greater accuracy and process reliability.

The magnetic air gap can be less than about 0.6 mm, in particular about 0.5 mm, for example, which means that the motor and, consequently, the electric pump can be structured to be very compact. A split pot is not required.

Preferably, the housing and the stator are jointly grounded by contacting the running axle. This enables effective protection against electrostatic discharge (ESD) and electromagnetic (EM) radiation from the motor.

The impregnating agent is preferably a resin from the epoxy family. The impregnating layer is preferably less than about 0.04 mm, for example, which allows for the smallest possible magnetic air gap between the stator and rotor.

In addition, the electric pump described above is intended for use as a coolant pump in a vehicle, preferably in a battery electric vehicle (BEV), hybrid electric vehicle (HEV), vehicle with an internal combustion engine (ICE), and/or fuel cell vehicle (FCV). The electric coolant pump can optimize thermal management with its cooling.

Preferably, the coolant pump has a power output in the range of about 50 W to about 600 W, in particular between about 100 W and about 300 W, for example. Preferably, it is a 12V pump, for example.

The above and other elements, features, steps, characteristics and advantages of the present invention will become more apparent from the following detailed description of the example embodiments with reference to the attached drawings.

### BRIEF DESCRIPTION OF THE DRAWINGS

Example embodiments of the present disclosure are described in more detail below with reference to the drawings. Identical components or components with identical functions are assigned identical reference signs.

FIG. 1 shows a longitudinal cross section of an assembly including a stator and a housing during vacuum impregnation according to an example embodiment of the present disclosure.

FIG. 2 shows a longitudinal cross section of an assembly according to an example embodiment of the present disclosure with a plug.

FIG. 3 shows a detailed view of a wire pull-through through the housing according to an example embodiment of the present disclosure.

FIG. 4 shows a longitudinal cross section through an electric coolant pump according to an example embodiment of the present disclosure.

FIGS. 5A and 5B show a longitudinal cross section through an assembly of a further example embodiment including a stator and housing, and a top view of a stator with housing.

FIG. 6 shows a longitudinal cross section through an electric coolant pump with the assembly shown in FIGS. 5A and 5B.

### DETAILED DESCRIPTION

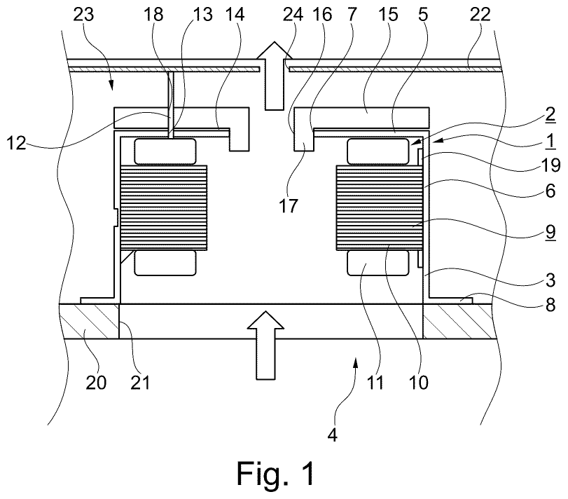

FIG. 1 shows an assembly 1 according to an example embodiment of the present disclosure which includes a stator 2 and a housing 3 in a vacuum impregnation system 4. The housing 3 is preferably pot-shaped with a base 5 and a circular cylindrical outer surface 6. A through-recess 7 is provided in the center of the base 5. The outer surface 6 is bent outwards at its end facing away from the base. The bend 8 defines a flange. The housing 3 of the electric motor is preferably made of thin-walled sheet metal, in particular sheet steel, and is formed by deep drawing. Sheet metal housings offer the advantage of similar thermal expansion as the sheet metal stack 9 of the stator 2, higher precision, better electromagnetic shielding, better heat conduction, higher strength, and a lower CO2-footprint.

However, the housing 3 can also be made of inexpensive plastics. Plastic housings offer the advantage of lower material costs, as plastics that are not resistant to coolants can also be used.

The stator 2 preferably includes a laminated core 9 including of a plurality of identical sheet metal laminations 10, which are preferably produced by punching and are stacked congruently on top of each other to define the laminated core 9. The sheet metal laminations 10, which are insulated from each other on their adjacent sides, are mechanically and electrically connected to each other. The stacked sheet metal laminations 10 preferably include grooves (not shown here) on their inner rim to receive a winding 11. A shown end 12 of a winding 11 is led out through a through-opening 13 in the bottom 5 of the housing 3. The opening 13 includes an insertion chamfer on the inside, which is used to align the winding end 12 when it is inserted into the opening 13. The winding topology of the stator 2 determines the number of winding ends. Preferably, one winding end is provided per motor phase.

In the present example embodiment of the assembly 1, a stiffening disc 15 is preferably arranged on an underside 14 of the base 5 (above in FIG. 1). The stiffening disc 15 is preferably a sintered disc made of porous material or an aluminum disc. An opening 16 with a raised rim 17 is provided in the center of the stiffening disc 15, which preferably defines a bearing seat of an axle (not shown). The rim 17 is structured such that it engages in the opening 7 in the base 5 of the housing 3 and extends into the interior of the housing 3. The stiffening disc 15 also includes an opening 18 permitting the winding end 12 to pass through. During assembly of the assembly, the winding ends 12 (phase wires) are preferably first pulled through the openings 13, 18 in the housing base 5 and the stiffening disc 15 and are aligned in the correct position. This eliminates the need for a separate busbar in the further course of assembly. The winding ends 12 are aligned parallel to a longitudinal axis of the assembly 2.

Before vacuum impregnation, the stator 2 is fastened to the inside of the outer surface 6 of the housing 3. The wound stator 2 is pushed against a stop 19 with a transition fit and fixed in place. This can be done by welding or by inserting the stator 2 between radially inwardly protruding beads in the outer surface 6. It is also conceivable that the stator could be caulked to the housing. This fastening option is discussed in detail below.

The vacuum impregnation system 4 preferably includes a base plate 20 on which the assembly 2 with the flange of the housing 3 is mounted. The base plate 20 includes an opening 21 that is adapted to the inner diameter of the housing 3 in the area of the outer surface 6. The base plate 20 defines an impregnation chamber 23 together with a cover 22. The impregnating agent is fed into the impregnation chamber 23 from a storage container located below the base plate 20, as symbolically represented by the arrows. The opening 21 in the base plate 20 functions as an inlet opening 21. An outlet opening 24 is provided in the cover 22 surrounding the assembly 1. A device to evacuate the impregnation chamber, for example, a vacuum pump system, which is not shown, provides the required negative pressure relative to the ambient pressure. This is preferably achieved by permanently evacuating the impregnation chamber 23 during the impregnation process. Alternatively, the impregnation chamber 23 can also be evacuated by a valve only when necessary, e.g., when a predetermined maximum pressure value is exceeded be connected to a device to evacuate the impregnation chamber 23, and otherwise be disconnected from it. The valve preferably includes a corresponding control to open or close the valve depending on the pressure.

The impregnating agent is preferably a resin from the epoxy family, for example. The surfaces of the vacuum impregnation system 4 that come into contact with the resin are preferably made of a plastic to which the resin does not adhere (PE, PA, PP, PC, etc.). The assembly 1, on the other hand, is completely wetted by the impregnating agent. As a result of capillary forces, the impregnating agent also creeps into the narrowest gaps, achieving the following effects:
bonding of the stator 2 to the housing 3,
bonding of the laminations 10 and the windings 11 of the stator 2,
bonding of the stiffening disc 15 to the housing 3,
sealing of the openings 13, 18 of the winding wire end feed-through, and
corrosion protection and electrical insulation by coating all surfaces.

During vacuum impregnation, the vacuum impregnation system 4 is preferably operated between about 40 mbar and about 60 mbar for about 11 minutes to about 18 minutes, for example. This is followed by curing at ambient pressure and a temperature in the range between about 150° C. and about 180° C. for at least approximately 2 hours, in particular at least about 3.5 hours, for example.

With the above features and operations, the inevitable drips which are formed by vacuum impregnating the entire assembly 1 can be limited to places where they do not interfere.

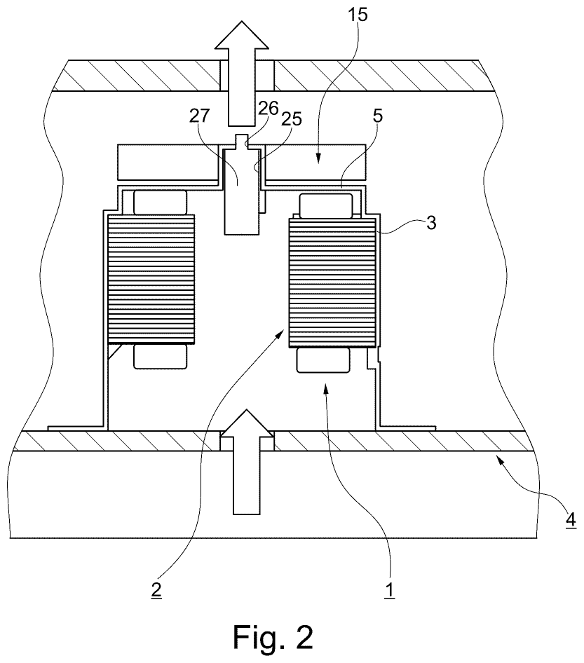

FIG. 2 shows an assembly 1 including a stator 2 and a housing 3 in a vacuum impregnation system 4. In contrast to the example embodiment shown in FIG. 1, the housing 3 includes a central recess 25 in the base 5, which defines a seat of an axle. An opening 26 is provided in the center of the recess 25 in the base 5. To ensure that the axle can be pressed into the recess 25 easily and precisely, the recess 25 is sealed with a plug 27, preferably made of rubber, during vacuum impregnation. This prevents the impregnating agent from entering into the recess 25 and ensures that the desired bore size for pressing in the axle and the precise geometry from the deep-drawing process are maintained in this area. This enables a precise press fit for the axle, which is not shown.

In contrast to the example embodiment shown in FIG. 1, the stiffening disc 15 is flat and surrounds the recess 25 on its circumference, so that the stiffening disc 15 can absorb the forces that occur when the axle is pressed into the recess.

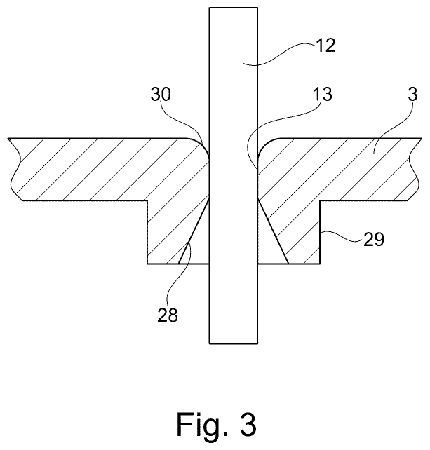

FIG. 3 shows in detail the opening 13 in the housing 3 and the winding wire end 12 passing through it. The insertion chamfer 28 described above is provided on the inside, and the housing 3 protrudes inward around the opening 13. The depth of the insertion chamfer 28 corresponds approximately to the height of the protrusion 29. On the outside, a recess 30 is provided around the opening 13 in the housing 3, in which the impregnating agent collects during vacuum impregnation, so that a deposit of impregnating agent is created during curing, ensuring a good sealing.

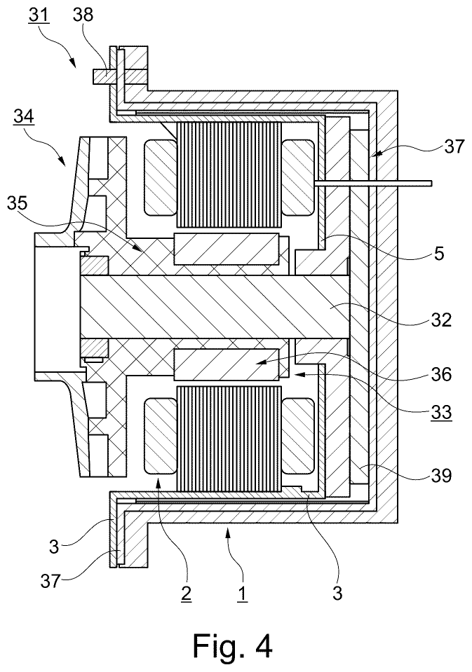

FIG. 4 shows a portion of an example embodiment of an electric coolant pump 31 with an assembly 1 including a housing 3 and a stator 2. A running axle 32 is pressed into the central seat in the base 5 of the housing 3. A rotor assembly 33 is rotatably mounted on the running shaft 32. The stator 2 thus surrounds the rotor assembly 33 on its circumference. The rotor assembly 33 includes an impeller 34 and a magnetic rotor 35 with a ferrite ring magnet 36 embedded on the outside. The magnetic rotor 35 is mounted rotatably on the drive shaft 32. The magnetic rotor 35 and the impeller 34 are preferably defined by a single monolithic piece, but could also be provided as separate pieces if so desired. At an end opposite the bearing seat, the magnetic rotor 35 includes a receptacle into which an axial thrust washer is pressed.

The housing 3 of the motor and a spiral housing (not shown) as well as a plug housing 37 are preferably aligned with each other by centering sleeves 38. The plug housing 37 is preferably an aluminum housing manufactured by deep drawing. The plug housing 37 contains a printed circuit board 39 and the assembly 1 with the stiffening disc 15. The printed circuit board 39 is connected to the outside of the bottom of the housing via a thermal pad, allowing it to be effectively cooled.

The running axle is preferably metallic and can be used to provide effective grounding of the stator. As shown in FIG. 2, when a plug is used during vacuum impregnation, the recess remains electrically conductive, which is advantageous for electromagnetic shielding, possible overall grounding, and heat conduction. With the formation of a ground pin (not shown) on the running axle 32, the housing 3, stator 2, and running axle 32 can be grounded together, providing effective protection against electrostatic discharge (ESD) and electromagnetic (EM) radiation from the motor.

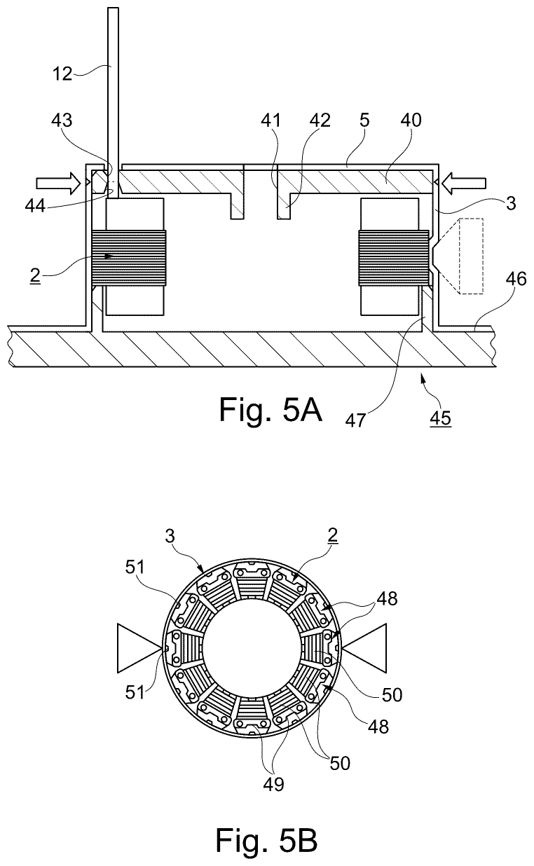

FIGS. 5A and 5B show another possible example embodiment. In contrast to the previous example embodiments, as shown in FIG. 5A), a stiffening disc 40 is preferably provided inside the housing 3. The stiffening disc 40 is in contact with the bottom 5 of the housing 3. The stiffening disc 40 preferably includes an opening 41 in the center and a raised rim 42 surrounding the opening 41, which extends inward into the housing 3, defining a bearing seat of an axle (not shown). The opening 41 is preferably coaxial and congruent with the opening 7 in the bottom 5 of the housing 3. The stiffening disc 40 additionally includes an opening 43 of the passage of the winding wire ends 12. The winding wire ends 12 are aligned parallel or substantially parallel to the longitudinal axis of the assembly by an insertion chamfer 44 defined in the opening 43. The stiffening disc 40 is held in the housing 3 by diametrical caulking. The caulking is symbolically represented by the arrows. The housing 3 and the stiffening disc 40 located therein are preferably caulked together from the outside by center punches.

In the present example embodiment, the stator 2 is placed on a positioning device 45 and the housing 3 is placed over the stator 2 and also set down on the positioning device 45. The positioning device 45 includes a flat surface 46 and a circular ring-shaped projection 47 located thereon. To position the stator 2, it is placed on the projection 47 and the housing 3 is placed on the flat surface 46. The position of the stator 2 in the housing 3 in terms of depth is thus defined by the height of the projection 47. After the stator 2 and the housing 3 have been placed on the positioning device 45, both parts 2 and 3 are caulked together diametrically from the outside using a center punch (shown schematically on the right-hand side of FIG. 5A).

As shown in FIG. 5B), the stator 2 preferably includes a plurality of stator core segments 48, each of which is assigned an insulator 49. Coils 50 made of winding wires are wound around the stator core segments 48 to define the armature and insulators 49, as shown schematically. The illustration does not reflect the winding topology. The insulators 49 each preferably include a longitudinally extending groove 51 in the center of a stator core segment, into which the housing 3 is pressed during caulking (symbolically represented by the arrows). The housing 3 can thus be firmly connected to the stator 2 before vacuum impregnation.

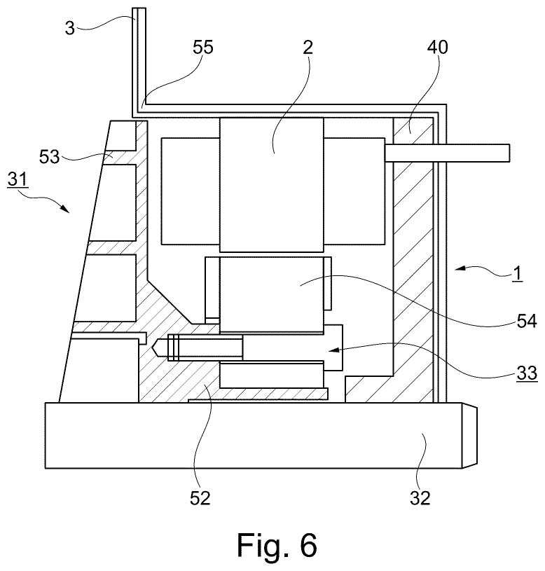

FIG. 6 shows a cross-section of a coolant pump 31 with an assembly 1 including of a stator 2 and a housing 3. As described in FIGS. 5A and 5B, the stator 2 was caulked to the housing 3 and a stiffening disc 40 was inserted into the housing 3. The assembly 1 was preferably surrounded by resin using vacuum impregnation as described above. A running axle 32 is connected in a rotationally fixed manner to the housing 3 and thus indirectly to stator 2. The rotor assembly 33 is rotatably mounted on the running axle 32. The rotor assembly 33 preferably includes a rotor adapter 52, which surrounds the running axle 32 circumferentially and defines an open impeller 53 at one end. A magnetic rotor 54 is located on the outside of the rotor adapter 52. The magnetic rotor 54 is screwed to the rotor adapter 52. The housing 3 of the motor can optionally be surrounded by an outer housing 55 as shown here.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric pump, comprising:
a motor housing;
a stator located in the motor housing; and
a rotor assembly circumferentially surrounding the stator; wherein
the motor housing is vacuum-impregnated and the rotor assembly is traversed by a stationary running axle pressed into the motor housing or into a stiffening disc connected to the motor housing.

2. The electric pump according to claim 1, wherein the motor housing is made of deep-drawn sheet steel.

3. The electric pump according to claim 2, wherein the motor housing and the stator are vacuum-impregnated as an assembly.

4. The electric pump according to claim 1, wherein
the rotor assembly is rotatably mounted on the running axle inside the stator; and
the rotor assembly includes an impeller and a magnetic rotor.

5. The electric pump according to claim 1, wherein
the housing is pot-shaped with a bottom and a cylindrical outer surface;
the base includes a central recess with a through-opening; and
the running axle is pressed into a seat defined by the recess.

6. The electric pump according to claim 1, wherein
the housing is pot-shaped with a bottom and a cylindrical outer surface;
the bottom includes a central through-opening;
a stiffening disc is located on an outside of the bottom and projects into the opening and into the interior of the housing with a circular ring-shaped projection; and
the inside of the circular ring-shaped projection defines a seat into which the running axle is pressed.

7. The electric pump according to claim 1, wherein
the housing is pot-shaped with a bottom and a cylindrical outer surface;
the bottom includes a central through-opening; and
a stiffening disc is located on an inner side of the bottom and includes an inwardly projecting circular ring-shaped projection, an inside of a circular ring-shaped projection defining a seat into which the running axle is pressed.

8. The electric pump according to claim 1, wherein the stiffening disc includes a through opening in a center of a circular ring-shaped projection.

9. The electric pump according to claim 5, wherein the seat of the running axle is free of an impregnating agent.

10. The electric pump according to claim 1, wherein a magnetic air gap between the stator and the rotor assembly is less than about 0.6 mm.

11. The electric pump according to claim 1, wherein the housing and the stator are jointly grounded by contacting the running axle.

12. A method of using the electric pump according to claim 1 as a coolant pump in a vehicle.
